(19) United States
(12) Patent Application Publication
(10) Pub. No.: US 2003/0002548 A1
(43) Pub. Date: Jan. 2, 2003

(54) LASER-DIODE ASSEMBLY WITH EXTERNAL BRAGG GRATING FOR NARROW-BANDWIDTH LIGHT AND A METHOD OF NARROWING LINEWIDTH OF THE SPECTRUM

(76) Inventor: Bogie Boscha, Metuchen, NJ (US)

Correspondence Address: Ilya Zborovsky, 6 Schoolhouse Way, Dix Hills, NY, 11746, US

(21) Appl. No.: 09/741,790

(22) Filed: Dec. 21, 2000

(51) Int. Cl. H01S 3/13

(52) U.S. Cl. 372/32

(57) ABSTRACT

Proposed are a laser-diode assembly with external Bragg grating for narrow-bandwidth light and a method of narrowing linewidth of the spectrum. A laser-diode assembly comprises a light source in the form of a semiconductor laser diode coupled via a first microoptical coupling device to one end of a first optical fiber. The other end of this fiber is coupled to a second or an output fiber via a second microoptical coupling device. The assembly is characterized by the fact that a laser cavity is extended rearward from the back facet of the laser diode and that the Bragg grating is located in the extended part of the cavity, so that the Bragg grating fulfills three functions, i.e., narrowing of the linewidth, frequency stabilization, and reflection of a portion of light to the resonator chamber.

### FIELD OF THE INVENTION

The present invention relates to the field of optoelectronics, in particular, to laser-diode units for generating a frequency-stabilized narrow-bandwidth light. The invention also relates to a method of generating a stabilized narrow-bandwidth light of a selected frequency. The invention may find application in various fields where short wavelength compact lasers are used, such as flat-panel displays, projection displays, optical data readers, optical sensors, laser measurement systems, optical data storage, etc.

### BACKGROUND OF THE INVENTION

At the present time, lasers find wide application in various fields. Especially in the recent years a tendency is observed for replacement of traditional solid-state and gas lasers with semiconductor lasers in view of their smaller dimensions, simplicity of use, and low cost. It is understood that such replacement is possible only if the replacement laser diodes possess at least the same properties with regard to the bandwidth characteristics and frequency stability as those in the lasers to be replaced. Semiconductor lasers with the above characteristics may find use in such fields as optical emission spectroscopy, laser-induced fluorescence analysis, transmission-absorption analysis, reflectometry, elipsometry, polarimetry, interferometry, Raman scattering analysis, non-linear optical diagnostics, etc.

One essential characteristic of a spectrum of light emitted by a semiconductor laser diodes is a linewidth, What is understood under the term “linewidth” in the context of the present patent application is the width of the light spectrum at the half of the height of the intensity-wavelength curve.

It is known that narrow linewidth sources are essential for optical systems such as coherent optical communications and optical sensors.

Attempts have been made to narrow the linewidth in distributed feedback or distributed Bragg reflector semiconductor lasers. For example, U.S. Pat. No. 6,075,805 issued to A. Cook, et al. in June 2000, describes an apparatus for linewidth reduction in distributed feedback or distributed Bragg reflector semiconductor lasers using vertical emission. According to the above patent, the linewidth of a distributed feedback semiconductor laser or a distributed Bragg reflector laser having one or more second order gratings is reduced by using an external cavity to couple the vertical emission back into the laser.

The authors of U.S. Pat. No. 6,075,805 state that use of an extended laser cavity in the direction that coincides with the optical axis of the laser diode would deteriorate the main laser beam because of interference of the beam reflected back to the laser cavity with the main light beam. The authors offer to solve this problem by utilizing an extension of the cavity, which is branched laterally from the optical axis direction. This is done by means of a Bragg grating formed on the active medium of the laser diode. This statement, however, is true for conventionally produced laser diode systems of non-microoptical type which have coatings on the rear and front faces of the laser diode with reflectivity of about 5%. It is understood that with 5% reflectivity the aforementioned reflectivity would be significant.

In the inventor's opinion, the proposed method and device prevent disturbance of the laser beam of main interest, provide unobstructed access to laser emission for the formation of the external cavity, and do not require a very narrow heat sink. Any distributed Bragg reflector semiconductor laser or distributed feedback semiconductor laser that can produce a vertical emission through the epitaxial material and through a window in the top metallization can be used. The external cavity can be formed with an optical fiber or with a lens and a mirror or grating.

It should also be noted with regard to the statement of U.S. Pat. No. 6,075,805 that the device and method described in this patent relate to laser cavities with relatively large ratios of the laser cavity length to the light beam diameter. In other words, the geometry inherent in the optical system of U.S. Pat. No. 6,075,805, as well as in other systems of this type, causes significant problems in optical alignment of the system components. This problem is aggravated in microoptical systems where the problems of optical alignment are especially critical and cannot be solved by conventional methods. Therefore, the device and method of U.S. Pat. No. 6,075,805 are not applicable to microoptical systems, especially to those, which are to be produced commercially. Furthermore, the heat sinks described and shown in U.S. Pat. No. 6,075,805 are too narrow and therefore would not be optically stable.

The above problem was partially solved in a device described in pending U.S. patent application Ser. No. ______ filed by the applicant of the present patent Application on ______ The device of this patent application describes a laser-diode assembly based on implementation of microoptical components for generating a frequency-stabilized narrow-bandwidth light. The device comprises a light source in the form of a semiconductor laser diode coupled via a first microoptical coupling device to one end of a first optical fiber. The other end of this fiber is coupled to a second or an output fiber via a second microoptical coupling device. The assembly is characterized by the fact that a long inner cavity is formed by a section of the optical system between two oppositely directed mirrors within the boundary of the device housing. The first mirror, which is almost 100% reflective, is applied onto the back side of the semiconductor laser diode, and the second mirror is applied onto a flat front side of one optical microlens element or onto the back side of another optical microlens element. These optical microlens elements are parts of an optical coupling between the first and the second fibers. The first mirror completely reflects the entire light incident onto this mirror, whereas the second mirror reflects a major part of the light, e.g., about 90% and passes only a small part, e.g., 10% of the light incident onto this mirror. The Bragg grating is designed so that, in combination with the laser cavity L, it suppresses the side modes of the wavelength bands and transforms them into the central mode of the narrow wavelength band which can be passed through this grating. The light processed by the Bragg grating is passed through the second mirror to the output fiber, while the reflected light performs multiple cycles of reflection between both mirrors which thus form a laser resonator which amplifies the laser light output at the selected narrow waveband.

Although the device described in U.S. patent application Ser. No. ______ is advantageous in that it provides a frequency-stabilized semiconductor laser assembly with a narrow linewidth of the light spectrum, the length of the laser cavity is limited to the boundaries of the device housing where both mirror are installed. Furthermore, the system of the aforementioned patent application uses for optimization of the gain in the semiconductor laser only one coating with about 1% reflection in the feedback beam. The second facet is closed with a fully-reflective mirror. Such a construction is difficult to produce, assemble, and adjust.

Another disadvantage is that the device of the aforementioned patent application requires the use of two different components, each for its specific function, i.e., a mirror for reflecting and Bragg grating for frequency selection and stabilization.

### OBJECTS OF THE INVENTION

It is an object of the invention to provide a laser-diode device, which is characterized by a very narrow linewidth in a spectrum of light of a selected wavelength. Another object is to provide a laser-diode device with an increased output signal/noise ratio, increased output light power at a selected narrow wavelength band, and stabilized frequency at the output. Another object is to provide a laser-diode device suitable for use in microoptical systems with possibility of efficient assembling and alignment under mass production conditions. Still another object is to provide a method of stabilizing frequency and narrowing the linewidth of the spectrum of the light emitted from the laser device through external extended laser cavity. Another object of the invention is to simplify the construction, assembling and adjustment by combining the functions of frequency stabilization, wavelength selection, and partial light reflection for maximizing the gain of the system in one optical component, which is a Bragg grating.

### SUMMARY OF THE INVENTION

Proposed is a laser-diode assembly with external Bragg grating for narrow-bandwidth light and a method of narrowing linewidth of the spectrum. A laser-diode assembly comprises a light source in the form of a semiconductor laser diode coupled via a first microoptical coupling device to one end of a first optical fiber. The other end of this fiber is coupled to a second or an output fiber via a second microoptical coupling device. The assembly is characterized by the fact that a laser cavity is extended rearward from the back facet of the laser diode and that the Bragg grating is located in the extended part of the cavity, so that the Bragg grating fulfills three functions, i.e., narrowing of the linewidth, frequency stabilization, and reflection of a portion of light to the resonator chamber.

### BRIEF DESCRIPTION OF THE DRAWINGS

FIG. 1 is a longitudinal sectional view of a laser-diode assembly of the invention.

FIG. 2 is a sectional view along the line II-II of FIG. 1.

FIG. 3 is a fragmental sectional view on a larger scale illustrating the butt connection of the fiber with the end face of the lens element.

FIG. 4 is a view of a system of the invention with the reflecting mirror on the front facet of the laser diode.

FIG. 5 is a view of a system of the invention with the reflecting mirror on the rear end face of the microlens element of the device for coupling the laser diode to the output optical fiber.

### DETAILED DESCRIPTION OF THE INVENTION

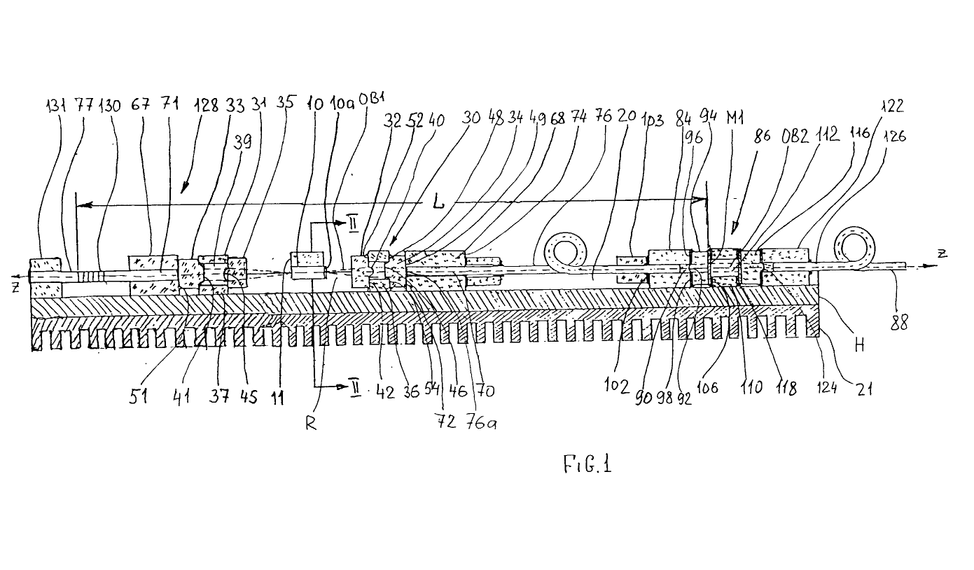

FIGS. 1-3—Embodiment of the Invention with External Bragg Grating in Conjunction with a Laser Diode

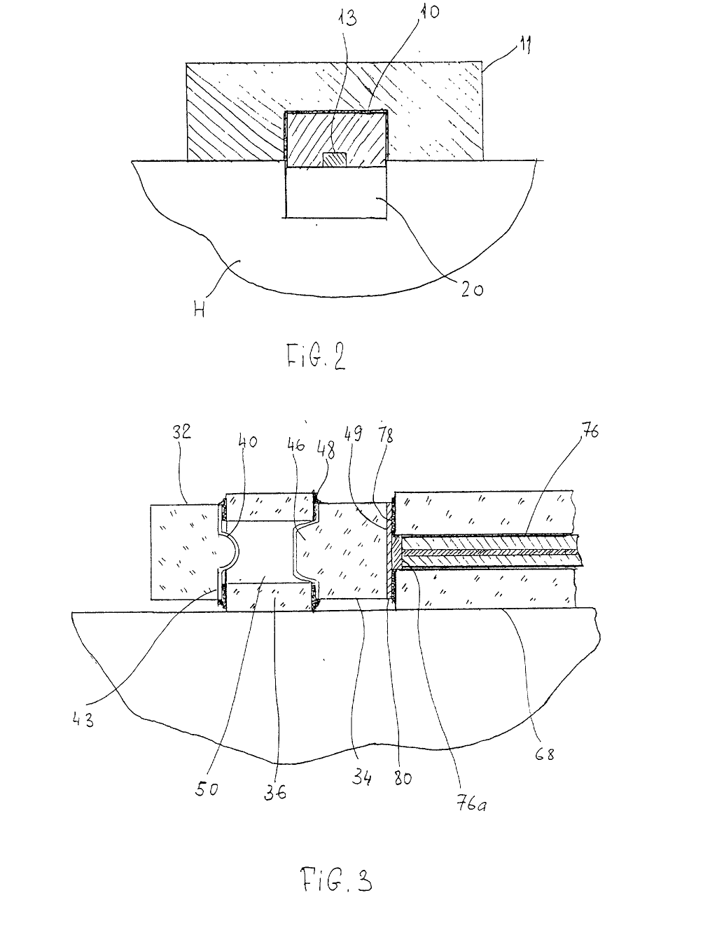

A laser-diode assembly of the invention is shown in FIG. 1, which is a longitudinal sectional view. The assembly as a whole is supported by a rectangular housing H, which has a longitudinal rectangular groove 20 shown in FIG. 2, which is a sectional view along the line II-II of FIG. 1. The housing H is connected to a heat sink 21 which may have an electric control (not shown). This groove serves for placement and centering of the components of the device. A unit, which in general is designated by reference numeral 30, consists of two lens elements 32, 34 and a spacer 36 sandwiched between them. This unit constitutes an anamorphotic lens assembly.

As shown in FIG. 2, in the illustrated embodiment the groove 20 has a rectangular cross section and a width that ensures gap-free fit of the optical system components, including the anamorphotic lens assembly 30. In such positions the aforementioned components are aligned with the optical axis of the laser diode assembly. The parts that form the lens assembly 30 are connected into an integral unit, e.g., by gluing with a UV-curable epoxy glue. If necessary, they can be connected by thermal fusion. The flatness and parallelism of the end faces, as well as the aforementioned dimensions of the components that form the lens assembly ensure self-alignment and self-centering of the components during assembling.

Each lens element comprises a rectangular, e.g., square plate made of glass, quartz, or any other suitable optical material having flat and strictly parallel front and rear sides or end faces and a cylindrical aspherical lens on the mating front sides.

Shown on the left side of the anamorphotic lens assembly 30 in FIG. 1 is a laser diode unit 10, which is mounted on a ceramic support 11 mounted on the housing H. The laser diode 10 is supported so that the center of its emitter 13 is located on the optical axis Z-Z of the lens assembly 30. An example of such a laser diode is a 916 nm single-mode edge-emitter type laser diode produced by Perkin Elmer Co. The laser diode of this type has a 1 μm×3 μm edge emitter. Another example is a laser diode of produced by Hitachi Co., Ltd. for radiating light with the wavelength of 635 nm. In fact, the principle of the invention is applicable to lasers of any types and designs that emit light with wavelengths in the range of 400 to 1600 nm. For example, the technology of the present invention also applicable to diodes of a VCSEL type with emitters on a vertical cavity.

The groove 20 (FIG. 2) of the housing H, which supports all the aforementioned components, functions as an aligning and centering element, as well as a temperature-stabilizing/heat sinking chassis of the laser diode chip and the optical assembly. The spacer 36 has a round cross section. The diameter of this round cross section is equal to the width of the groove 20.

The lens element 32 (FIGS. 1 and 2) comprises a plate with an aspherical cylindrical lens 40 on the front end face 42 that faces the lens element 34. Similarly, the lens element 34 comprises a square plate with an aspherical cylindrical lens 46 on the front end face 48 that faces the lens element 32. The backside, e.g., the end face 49 of the lens element 34 is strictly parallel to the end face 48 of this element. The aspherical cylindrical lenses 40 and 46 have their longitudinal axes respectively, turned by 90° relative to each other. In the illustrated embodiment, the lenses 40 and 46 are made integrally with the plate-like bodies of the lens elements 32 and 34, respectively, e.g., by chemical etching. If necessary, however, they can be produced by cutting a cylindrical body in a longitudinal direction and then gluing the half-cylinders to the end faces of the plates.

The spacer 36 is a ring-like element with a central hole 50 and two strictly parallel and flat end faces 52 and 54. The reason that all aforementioned end faces should be strictly parallel to each other is that they function as reference surfaces for assembling. Their surface condition should ensure that deviation of the lenses 40, 46 from parallelism does not exceed 2 μm.

A distance R (FIG. 1) from the emitter of the laser diode 10 to the lens element 34 is within the range of 1 to 100 μm. The shortened distance between the emitter of the laser diode 10 and the lens element improves optical coupling efficiency, as compared to the TO-can mounting where this distance is relatively large. It is important to ensure divergence of the optical beam OB1 corresponding to the input aperture of the anamorphotic lens assembly 30 for full optical coupling of the optical components.

The optical lenses 40 and 46 have the same length in the direction of their respective longitudinal axes and this length has a magnitude that ensures gap-free snug fit of the lenses 40 and 46 in the hole 50 of the spacer 36 when the unit is assembled by sandwiching the spacer 36 between the lens elements 32 and 34 and the parts are secured together, e.g., by an optical glue, e.g., a UV-cured NOA-61 epoxy-type adhesive. Alternatively, the parts can be secured together by means of laser welding, such as glass-to-glass YAG laser welding.

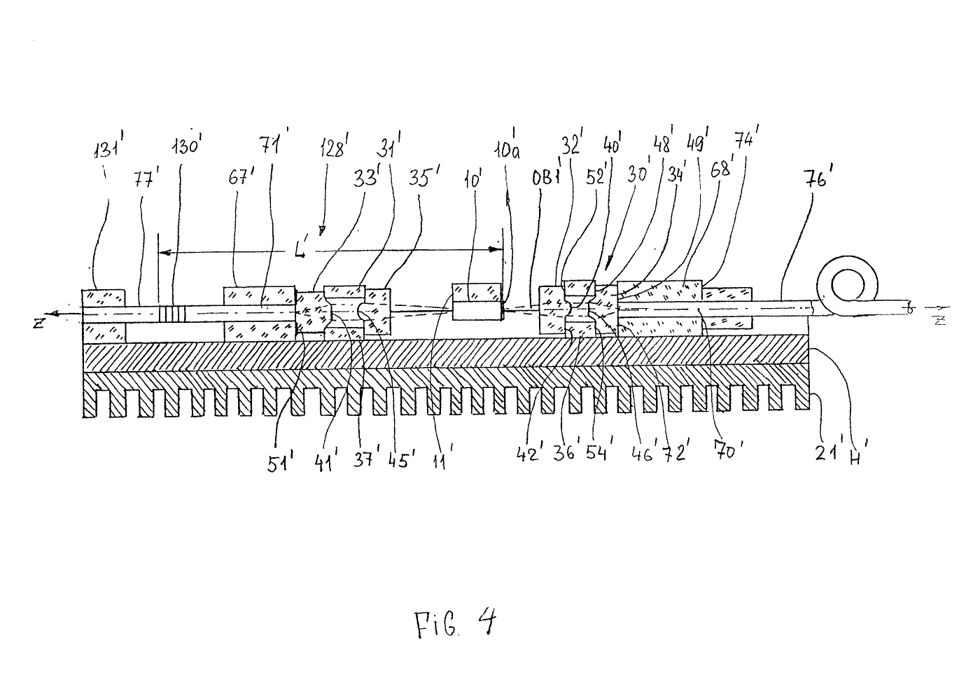

Located on the side of the anamorphotic lens assembly 30 opposite to the laser diode 10 is a glass ferrule 68 with a central opening 70 and end faces 72 and 74. The ferrule 68 is also positioned in the groove 20. The external diameter of the ferrule 68 is equal to that of the spacer 36, and therefore the ferrule 68 is also self-centered in the groove 20. The end face 72 of the glass ferrule 68 is strictly parallel to the end face 49 of the lens element 34 with deviation from flatness of less than 1 μm. An optical fiber 76 is inserted into the central opening 70 so that its front end face 76a has a butt connection with the rear end face 49 via a thin layer 78 of a UV-curable optically matched epoxy glue (such as NOA-61 type adhesive) which is used for attaching the ferrule 68 as well as the end face 76a of the optical fiber 76 to the end face 49 of the lens element 34. This is shown in FIG. 3, which is a fragmental sectional view on a larger scale illustrating the butt connection of the fiber with the end face of the lens element.

The glue layer has a thickness of about 4-5 μm. The butt connection of the fiber to the flat side of the lens element ensures automatic positioning of the fiber in the device and thus simplicity and repeatability of such positioning under conditions of mass production. It is understood that reference numeral 76 designates both the core and the clad of the optical fiber, which are not designated separately.

It is obvious that the optical axes of the fiber 76, the laser diode 10, and the anamorphotic lens assembly 30 are strictly linear and coincident in all these components.

The flat surface 43 (FIG. 3) of the lens element 32, including the lens 40, the flat surface 49 of the lens element 34, including the lens 46 have anti-reflective coatings (only one of which, i.e., the coating layer 80 on the flat surface 49 is shown in FIG. 3). This coating 80 is index-matched with a glue layer 78, e. g., a NOA-61 optical epoxy layer shown in FIG. 3, which may have a maximum thickness of about 4-5 μm. This improves optical coupling of the lens to the fiber and eliminates mechanical mismatch that may be caused by thermal deformations.

The end of the fiber 76 opposite to the lens assembly 30 is inserted into a ferrule 84 of another optical coupler 86 (FIG. 1), which connects the fiber 76 with an output optical fiber 88. As can be seen from this drawing, the ferrule 84 has a through opening 90. The end of the fiber 76 is inserted into one end of this opening, while an aspheric circular microlens 92 of a plate-like microlens is inserted with a tight fit into the opposite end of the opening 90. The microlens element 94 is glued to the mating end face 96 of the ferrule 84 with a layer 98 of a UV-curable glue. The aforementioned end of the fiber 76 is located a certain distance from the aforementioned aspheric circular microlens 92. This distance ensures formation of a collimated light beam OB2 in a tubular separator 110 which is mentioned below.

When the fiber 76 is fixed in the ferrule 84 by a layer 102 of a UV-curable glue, the fiber end face should be in an exact location with respect to the microlens 92. If necessary, the exact positioning and fixation of the fiber end face can be facilitated by using an additional ferrule 103 and a layer 102 of the glue.

The flat end face of the microlens element 94 is coated with a mirror coating M1 which passes only a fraction, e.g., about 10% of a selected narrow wavelength band of light incident on this mirror coating and reflects the remaining 90% of the selected wavelengths band of light through the fiber 76 back toward the laser. The 10%/90% ratio may vary to suit specific application and a desired power spectrum relation. For example, for red light the selected band may be of 635 nm±0.4 nm. The semiconductor laser diode 10 may be, e.g., the one that generates light in the spectrum band of 635 nm±12.5 nm (semiconductor laser diodes produced by Hitachi, Sony, Toshiba, Phillips, etc.). The mirror M1 will reflect approximately 100% of light except for the portion that corresponds to the wavelength of 635 nm±0.4 nm.

The flat rear end face of the microlens element 94 is glued via a layer 106 of a UV-curable glue to the front end face of the aforementioned tubular separator 110 having a central opening 112 of a diameter larger than the diameter of the fiber 76.

The flat front end face of another plate-like microlens element 116 is glued via a layer 118 of a UV-curable glue to the rear end face of a ferrule 122. A circular aspheric microlens 124, which is formed on the flat front side of the microlens element 116 inserted into a through opening 126 of the ferrule 122. An output optical fiber 88 of the entire system is inserted into the end of the opening 126, which is opposite to the fiber 76. The end face of the fiber 88 should be located at a predetermined distance from the lens 124. In a real construction, positioning and fixation of end faces of respective fibers 76 and 88 are carried out so as to obtaining the maximum output light signal in the fiber 88.

Located on the left side of the laser diode 10 in FIG. 1 is an optical component of the system, which contains an extension unit 128 of the laser cavity L that is described later. By definition from Photonics Dictionary published in 1993 by the Publisher of Photonic Spectra Magazine, a laser cavity is an optical resonant structure, in which lasing activity begins when multiple reflections accumulate electromagnetic field intensity. It is difficult, however, to define a laser cavity in an optical system, which has many reflecting surfaces, which limit the area with lasing activity. Therefore, in the present patent application we define the laser cavity as a space from the mirror M1 to the Bragg grating 130. More specifically, the laser cavity extension unit 128 consists of a second anamorphotic objective 31 formed by a pair of microlens elements 33 and 35 with a spacer 37 between them. The second anamorphotic objective has the same construction and arrangement of parts as the first anamorphotic objective 30 described above. In other words, its end faces are flat and parallel to each other and are treated to a high degree of flatness in order to provide self-alignment and accurate coaxiality with the optical axis of the system during assembling. Similar to the fiber support and positioning system of the previously described couplings, the unit 128 has a cylindrical ferrule 67, which is centered in the groove 20 of the housing H coaxially with the rest of the optical system components.

A locking optical fiber 77 is inserted into a central through opening 71 of the ferrule 67 and is butt-connected to the flat rear end face 51 of the microlens element 33 with the butt connection described with reference to FIG. 3. A cylindrical aspherical microlens 41 of the microlens element 33 is snuggly fitted into the central opening 39 of the spacer 37. Similarly, a cylindrical aspherical microlens 45, which has its longitudinal axis perpendicular to that of the microlens 41, is snuggly fitted into the opening 39 of the spacer 37 from the side opposite to the microlens element 33.

In fact, the assembly consisting of the microlens elements 33, 35, spacer 37, and the ferrule 67 is identical to the assembly of microlens elements 32, 34, etc., which is mirror-image construction of the assembly locate on the left side from the laser diode 10. The left-side assembly has the same antireflective coatings and UV-curable glue layers as the right-side assembly, and therefore their description is omitted.

As shown in FIG. 1, the locking fiber 77 has a Bragg grating 130 written into the core of the optical fiber. The position of the Bragg grating 130 depends on a specific design and can be anywhere along the length of the locking fiber 77. The applicant has successfully tested laser-diode assemblies of the invention with the different lengths of the fiber 77 within the range of 2 cm to 20 cm.

The free end of the locking fiber, behind the Bragg grating 130, is supported by a ferrule 131. It is understood that all ferrules 131, 67, 68, 84, and 122, as well as the spacers 31, 36, and 110 have the same diameters, which are equal to the width of the groove 20 of the housing H. This ensures self-centering and alignment of the fiber-supporting elements and, hence, of the fibers themselves in the optical system of the invention.

The Bragg grating 130, the portion of the locking fiber 77 from the Bragg grating to the butt connection with the anamorphotic objective 31, the objective 31 itself, the space between the anamorphotic objective 31 and the rear end of the laser diode 10, the laser diode 10 itself, the space between the laser diode 10 and the anamorphotic objective 30, the anamorphotic objective 30 itself, the entire optical fiber 76, and the distance from the front end of the fiber 76 to the mirror coating M1 on the flat end face of the lens element 94 form an extended laser cavity L.

It can be seen that in contrast to the laser cavity L of the system disclosed in the earlier U.S. patent application Ser. No. ______, light source, i.e., the laser diode 10 is an intercavity element, which is located between the Bragg grating on one side and the laser mirror M1 on the other side. This means that the length of the laser cavity can be extended to a much greater degree than in the previously described construction. Another advantage is that there is no need to form a full-reflection mirror on the back facet of laser diode 10, or another source such as a semiconductor amplifier, or a superluminescent emitting diode. This is an important advantage since the laser diode works in an intensive temperature and light-power density mode which require that for reliability of operation the mirror coating on the laser be produced with an extremely high quality.

In the system of the present invention, the function of the aforementioned full-reflection mirror of the system, described in the aforementioned U.S. patent application, is fulfilled by the Bragg grating 130. Along with the function of the full-reflection mirror, the Bragg grating 130 selects the linewidth and ensures optical power stability.

Bragg gratings are also known as distributed Bragg reflectors, which are optical fibers or other media that have been modified by modulating the longitudinal index of refraction of the fiber core, cladding or both to form a pattern. A fiber equipped with Bragg grating functions to modify the optical passband of the fiber (transmission characteristic) in such a way as to only transmits a narrow and controlled wavelength band. The distributed Bragg reflectors typically are “lossless” devices. In principle, the Bragg gratings can be used as light reflectors or as spectrum shape or mode converters.

A typical distributed Bragg reflector comprises a length of optical fiber including a plurality of perturbations in the index of refraction substantially equally spaced along the fiber length. These perturbations selectively reflect light of wavelength λ equal to twice the spacing A between successive perturbations times the effective refractive index, i.e., λ=2n_{eff} Λ, where λ is the vacuum wavelength and n_{eff} is the effective refractive index of the fiber for the mode being propagated. The remaining wavelengths pass essentially unimpeded. In the system of my invention, such a distributed Bragg grating 130 is used as a spectrum shape and mode converter for narrowing the spectrum bandwidth of the light radiated from the laser diode 10, as well as for stabilization of the output laser diode characteristics and for gaining the light energy which is resonated within the laser cavity L.

By selecting an appropriate periodic spacing Λ between successive perturbations in the fiber 77 with the distributed Bragg grating reflector 130, it becomes possible to select a mode, which is the most efficient for the operation of the semiconductor laser diode 10. In the system of the invention, such a mode is the one with the maximum intensity in the laser radiation spectrum. At the same time, the gain of the maximum intensity mode is accompanied by the suppression of the side modes of the spectrum.

Although only one antireflective coating 80 is shown on the end face 49 (FIG. 3), anti-reflective coatings (not shown) can be applied onto the end faces of optical fiber 77, of the microlens elements 33, 35, 32, 34, etc.

The optical system shown in FIGS. 1-3 operates as follows:

After the semiconductor laser 10 (FIG. 1) is activated, a diverged light beam, e.g., of 635 nm±12.5 nm wavelength emitted by the laser 10, propagates in both directions, i.e., toward the Bragg grating 130 and toward the output optical fiber 88.

The photons which propagate toward the Bragg grating 130 (FIG. 1) propagate through the anamorphotic objective 31 and are turned into a focused beam, which is coupled into the optical fiber 77. On its way, the light enters the distributed Bragg grating 130, which reflects the wavelength in the selected narrow bandwidth. A portion of the selected mode spectrum is reflected back to the laser diode 10. Immediately after initiation of the light-generation operation (fractions of nanoseconds), the system is self-adjusted to a mode operation in which the spectrum of the generated light will be readjusted to the narrow linewidth mode which will be further maintained due to operation of the Bragg grating 130.

In other words, the photons reflected from the Bragg grating 130 will propagate toward the mirror M1. After initiation of the laser diode 10, the process takes few cycles of photon reflections back and forth between the Bragg grating 130 and the mirror M1 (the cavity length), whereby the laser cavity enables light amplifications, i.e., gain for the selected wavelength.

The intensified light of the selected mode then enters the microlens 92 of the microlens element 94 and passes to the lens element 116 via the mirror M1 and through the opening 112 of the spacer 110 to the microlens element 116. The mirror M1 passes only a portion, e.g., 75-99%, of the light in the selected wavelength band, e.g., of 635±0.4 nm, to the output fiber 88. The remaining portion of the light, e.g. 1 to 25%, is reflected back to the Bragg grating 130 via the aforementioned optical elements of the laser cavity L. In the case of the system of the invention, the optimum conditions were achieved at back reflection of 15-25%. When this reflected light enters the Bragg grating 130, the process of spectrum transformation and intensification of light of a selected wavelength with suppression of side modes is repeated. Thus, if 1% of the light is reflected back for use in maximization of the gain of the laser system, this relatively weak feedback beam will not interfere with the main beam of the interest. In one of the designs tested by the applicant, the maximum gain was obtained when the emitter of the laser diode 10 was coated with a coating having reflectivity below 1%.

Similarly, the photons which are emitted from the laser diode in the direction opposite to the Bragg grating 130, in the direction of the output optical fiber 88, first pass through the lens element 32, the microlens 40 of which focuses this beam on the end face of the optical fiber 76. The focused beam is then propagates through the optical fiber 76 towards the mirror M1, which effects this beam toward the Bragg grating 130. On its way to the Bragg grating 130 the light beam is processed in the order reversed to steps in the direction of the mirror M1. The rest of the processing of this portion of the light beam which has initially been propagated towards the mirror M1 is the same as has been described with regard to the light beam initially directed from the laser diode 10 to the Bragg grating.

Such an arrangement makes it possible to maintain high level of light radiation power on the selected frequency, which in the illustrated embodiment is the frequency of 635±0.4 nm. In combination with temperature control via a heat sink 21, it becomes possible to ensure long-term stability of the output light power with deviations not exceeding, e.g., 1%, or even lower than 0.1%. Furthermore, the laser cavity with the external Bragg grating 103 may have an extremely long dimension, as compared to the length of a semiconductor diode chip. This allows not only obtaining of an extremely narrow linewidth, but also high stability of the frequency which is typical of laser systems with large external resonators.

The system of the invention has a simplified construction, assembling and adjustment by utilizing a three-functional component, which is the Bragg grating 130. These functions are frequency stabilization, narrowing of the line width, and partial light reflection for maximizing the gain of the system.

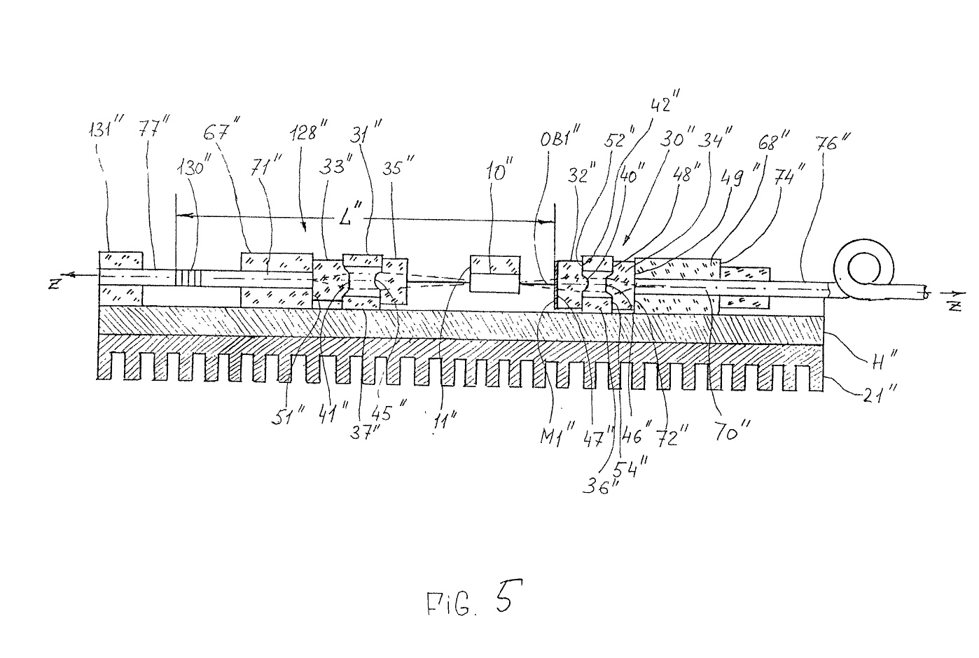

FIG. 4—Embodiment of the Laser-diode Assembly with External Laser Cavity and Reflecting Mirror on the Front Facet of the Laser Diode

The embodiment of the invention shown in FIGS. 1-3 is advantageous in that it allows the use not only a custom-designed laser but also a commercially produced light source. However, further simplification of the construction with elimination of one of optical couplings and one of optical fibers can be accomplished by means of an embodiment shown in FIG. 4. This embodiment, in general, is similar to that shown in FIGS. 1-3 and differs from it by eliminating the output optical fiber 88 and the optical coupling (84, 86, 122). In the embodiment of FIG. 4, the parts identical to those of FIGS. 1-3 are designated by the same reference numerals with an addition of a prime. An additional reference numeral 47′ designates a rear end face of the microoptical lens element 32′. Furthermore, the reflecting mirror M1 is transferred to the front facet 10a′ of the laser diode 10′. The function of the output fiber 88 is transferred to a fiber 76′. In compliance with the principle of the present invention, the laser diode 10′ remains between the Bragg grating 130′ of the cavity extension fiber 77′ and the reflecting mirror M1′. The length of the laser cavity L′ can be chosen without limitations, as in the previous embodiment. The principle of operation also remains the same and therefore is skipped from the description.

FIG. 5—Embodiment of the Invention with the Reflecting Mirror on the Rear End Face of the Microlens Element of the Device for Coupling the Laser Diode to the Output Optical Fiber

FIG. 5 illustrate an embodiment of the invention which is similar to one shown in FIG. 4 but differs from it only by the position of the reflecting mirror. Since both embodiments are very similar, in FIG. 5 the parts identical to those of FIG. 4 are designated by the same reference numerals but with two primes. For example, the laser cavity L′ of the embodiment of FIG. 4 corresponds in FIG. 5 to the laser cavity L′. Furthermore, the description of the identical parts and of their operation is omitted.

The main distinction of the embodiment of FIG. 5 from the embodiment of FIG. 4 is that the reflecting mirror M1″ is formed on the back end face 47″ of the microoptical lens element 32″. Thus, the laser cavity L″ is formed between the Bragg grating 130″ and the reflecting mirror M1″. The operation of the system of FIG. 5 is the same as of the system of FIG. 4.

Thus it has been shown that the invention provides a laser-diode device, which is characterized by a very narrows linewidth in a spectrum of light of a selected wavelength, an increased output signal/noise ratio, increased output light power at a selected narrow wavelength band, and stabilized frequency at the output. The device of the invention is suitable for use in microoptical systems with possibility of efficient assembling and alignment under mass production conditions. The invention also provides a method of stabilizing frequency and narrowing the linewidth of the spectrum of the light emitted from the laser device through external extended laser cavity. The invention simplifies the construction, assembling and adjustment by combining the functions of frequency stabilization, wavelength selection, and partial light reflection for maximizing the gain of the system in one optical component, which is a Bragg grating.

Although the invention has been described with reference to specific embodiments, it is understood that these embodiments were given only for illustrative purposes and that any changes and modifications with regard to shapes, designs, materials, and combinations thereof are possible, provided these changes and modifications do not depart from the scope of the patent claims. For example, the light source may comprise a superluminescent laser diode, a laser diode with an amplifier, etc. The housing H can be divided into two separate parts, one for the laser unit with the first coupling and anamorphotic lens assembly, and another one with the second coupling and the output fiber. This will allow individual temperature control optimal for separate units. The connection of the optical elements can be achieved by thermal fusion, rather than by adhesion. The mirror and the Bragg grating can be located in positions different from those described and shown in the illustrated embodiments, e.g., the first mirror can be installed on a separate support behind the semiconductor laser diode and at a distance from this diode.

1. A method for selecting and stabilizing frequency of light emitted by a semiconductor laser diode, comprising:
providing a system of optical components arranged in the direction of light propagation, said system comprising a semiconductor laser diode that radiates a light of a given wavelength band, an input optical fiber, a three-functional component, a reflecting mirror, a laser cavity formed by a part of said optical components of said system between said three-functional component and said reflecting mirror, said three-function component incorporating functions of frequency stabilization, wavelength selection, and partial light reflection for maximizing the gain of the system in one optical component, said three-functional component reflecting 100% of light incident on said three-functional component, said reflecting mirror passing only a selected portion of said light of a predetermined frequency and contains a frequency selection means for selecting a light of a predetermined frequency in said given wavelength band, a first coupling means for coupling said semiconductor laser diode to said input optical fiber, an output optical fiber, a second optical coupling for coupling said input optical fiber with said output optical fiber, said semiconductor laser diode being located within said laser cavity between said three-functional component and said reflecting mirror;
generating said light of said given wavelength band by said semiconductor laser diode;
passing said light having said given wavelength band through said frequency selection means;
selecting light of a predetermined frequency in said given wavelength band and narrowing said given wavelength band;
propagating the light of narrowed wavelength band further to said reflecting mirror;
passing only the light of said narrowed wavelength band through said reflecting mirror to said output optical fiber;
reflecting the remaining portion of said light of a predetermined frequency back to said three-functional component;
selecting a chosen frequency by means of said three-functional component;
reflecting said remaining portion of said light of said chosen frequency from said three-functional component; and
continuing generating said light of said given wavelength band by said semiconductor laser diode, while repeating, for the light reflected from said reflecting mirror, at least once all said steps starting from said step of passing said light through said frequency selection means.

2. The method of claim 1, further comprising the step of stabilizing the output power of the light sent to said output optical fiber by controlling the temperature of said part of said optical components that forms said laser cavity.

3. The method of claim 1, wherein said three-functional component comprises a Bragg grating.

4. The method of claim 2, said three-functional component comprises a Bragg grating.

5. The method of claim 4, wherein said second coupling comprises at least one of said optical components with a flat surface which is strictly perpendicular to said direction of light propagation, said reflecting mirror being applied onto said flat surface.

6. The method of claim 5, wherein said first coupling means comprises at least a lens assembly.

7. The method of claim 6, wherein said lens assembly is an anamorphotic lens assembly.

8. A laser-diode assembly for generating a frequency-stabilized narrow-bandwidth light having a light propagation direction, said laser-diode assembly being composed of optical components arranged in the direction of light propagation, said laser assembly comprising:
a semiconductor laser-diode that radiates a light of a given wavelength band;
an input optical fiber;
an output optical fiber;
a laser cavity extension fiber, said semiconductor laser diode being located between said laser cavity extension fiber and said input optical fiber;
a three-functional component, which is formed in said laser cavity extension fiber and incorporates functions of frequency stabilization, wavelength selection, and partial light reflection for maximizing the gain of the light generated by said laser-diode assembly;
a reflecting mirror, which is located between said input optical fiber and said output optical fiber and which reflects a fraction of light that passed through a part of said optical components to said reflecting mirror back to said three-functional component and passes only a selected portion of light of a predetermined frequency of a given wavelength band;
a laser cavity formed between said three-functional component and said reflecting mirror, said three-functional component selecting a light of said predetermined frequency in said given wavelength band;
a first coupling means for coupling said semiconductor laser diode to said input optical fiber;
a second optical coupling for coupling said input optical fiber to said output optical fiber; and
a third optical coupling for coupling said cavity extension fiber to said semiconductor laser diode.

9. The laser-diode assembly of claim 8, further comprising means for controlling temperature of said part of said optical components that forms said laser cavity.

10. The laser-diode assembly of claim 8, wherein said three-functional component is a Bragg grating.

11. The laser-diode assembly of claim 10, wherein said second coupling comprising at least one of said optical components with a flat surface which is strictly perpendicular to said direction of light propagation, said reflecting mirror being formed on said flat surface.

12. The laser-diode assembly of claim 11, wherein said first coupling means comprises at least a first lens assembly.

13. The laser-diode assembly of claim 12, wherein said third coupling means comprises at least a second lens assembly.

14. The laser-diode assembly of claim 13, wherein said first lens assembly and said second lens assembly are anamorphotic lens assemblies.

15. The laser-diode assembly of claim 9, wherein said first coupling means comprises at least a lens assembly.

16. The laser-diode assembly of claim 15, wherein said lens assembly is an anamorphotic lens assembly.

17. The laser-diode assembly of claim 16, wherein said first lens assembly and said second lens assembly are anamorphotic lens assemblies.

18. The laser-diode assembly of claim 13, wherein said first anamorphotic lens assembly comprises at least a part of said input optical fiber which has one end in butt connection with said first lens assembly, said second anamorphotic lens assembly comprising at least a part of said cavity extension fiber which has one end in butt connection with said second lens assembly, a first optical fiber ferrule with a through opening for another end of said input optical fiber, a first microlens element with a first circular aspherical microlens inserted into said through opening from the side opposite to said input optical fiber, a second microlens element with a second circular aspherical microlens, a spacer between said first microlens element and said second microlens element, and a second optical fiber ferrule with a through opening, said second circular aspherical microlens being inserted into said through opening of said second optical fiber ferrule from one side thereof, said output optical fiber being inserted into said through opening of said second optical fiber ferrule from a side opposite to said one side thereof.

19. The laser-diode assembly of claim 18, further comprising a third optical fiber ferrule with a through opening for said cavity extension fiber.

20. A laser-diode assembly for generating a frequency-stabilized narrow-bandwidth light having a light propagation direction, said laser-diode assembly being composed of optical components arranged in the direction of light propagation, said laser assembly comprising:
a semiconductor laser-diode that radiates a light of a given wavelength band and has a front facet and a rear facet;
an output optical fiber optically coupled to said front facet;
a laser cavity extension fiber optically coupled to said rear facet;
a three-functional component, which is formed in said laser cavity extension fiber and incorporates functions of frequency stabilization, wavelength selection, and partial light reflection for maximizing the gain of the light generated by said laser-diode assembly;
a reflecting mirror means, which reflects a fraction of light that passed through a part of said optical components to said reflecting mirror, back to said three-functional component and passes only a selected portion of light of a predetermined frequency of a given wavelength band;
a laser cavity formed between said three-functional component and said reflecting mirror, said three-functional component selecting a light of said predetermined frequency in said given wavelength band;
a first coupling means for coupling said cavity extension fiber to said rear facet of said semiconductor laser diode; and
a second optical coupling for coupling said output optical fiber to said front faces of said semiconductor laser diode.

21. The laser-diode assembly of claim 20, further comprising meansfor controlling temperature of said part of said optical components that forms said laser cavity.

22. The laser-diode assembly of claim 20, wherein said three-functional component is a Bragg grating.

23. The laser-diode assembly of claim 27, wherein said first coupling comprises at least one of said optical components with a flat surface which is strictly perpendicular to said direction of light propagation, said reflecting mirror being formed on said flat surface.

24. The laser-diode assembly of claim 21, wherein said first coupling means comprises at least a first lens assembly.

25. The laser-diode assembly of claim 24, wherein said second coupling means comprises at least a second lens assembly having a flat end-face surface on the side facing said laser diode.

26. The laser-diode assembly of claim 25, wherein said first lens assembly and said second lens assembly are anamorphotic lens assemblies.

27. The laser-diode assembly of claim 25, wherein said laser diode assembly has an optical axis, said first lens assembly comprising at least a part of said cavity extension fiber which has one end in butt connection with said first lens assembly, a first optical fiber ferrule with a through opening for supporting said cavity extension fiber, a first microlens element with a first microlens, a second element with a second microlens, a spacer between said first microlens element and said second microlens element, said spacer having a through opening, said first microlens being inserted with a tight fit into said through opening of said spacer from one side of said spacer, said second microlens being inserted with a tight fit into said through opening of said spacer from the side opposite to said one side, said first and second microlenses having longitudinal axes perpendicular to each other and to the optical axis of said laser diode assembly.

28. The laser-diode assembly of claim 20, wherein said reflecting mirror is formed on said front facet of said semiconductor laser diode.

29. The laser-diode assembly of claim 25, wherein said reflecting mirror is formed on said flat end-face surface.
